(19) United States
(12) Patent Application Publication
(10) Pub. No.: US 2008/0005619 A1
(43) Pub. Date: Jan. 3, 2008

(54) Validation of software execution paths

(76) Inventors: Tamarah Arons, Binyamina (IL); Elad Elster, Haifa (IL); Michael Mishaeli, Zichron (IL); Eli Singerman, Haifa (IL); Andreas Tiemeyer, Aberdeen (GB)

Correspondence Address: Lee & Hayes, PLLC;c/o Intellevate, P.O. Box 52050, Minneapolis, MN, 55402, US

(21) Appl. No.: 11/477,847

(22) Filed: Jun. 29, 2006

(51) Int. Cl. G06F 11/00

(52) U.S. Cl. 714/38

(57) ABSTRACT

Embodiments of software execution path validation are presented herein.

### BACKGROUND

The complexity of software is ever increasing as functionality is continually added to increase the usefulness of the software when executed by devices. For example, software may be configured as microcode which is maintained within a processor to fill a “gap” between assembly code and hardware capabilities of the processor. As hardware capabilities are added to the processor and/or software capabilities are added to the assembly code, additional complexity may also be added to the microcode. In another example, the software may be configured as an executable module to provide a variety of functionality, such as a device driver, a word processor, assembly code as previously described, a game, and so on. Thus, software may be continually expanded and developed to increase the usefulness of the software to provide this functionality.

However, with the increase in the complexity of software has come a corresponding increase in the difficulty in validating the software. For example, software may have a multitude of execution paths due to inclusion of conditional statements. Therefore, traditional techniques which were traditionally utilized to manually validate software may be insufficient when confronted with modern software having a high-degree of complexity. For example, manual validation of each of these execution paths may be resource intensive and require numerous hours of work by a software engineer, which may be costly. Further, manual validation may introduce human error, which may also be costly.

### BRIEF DESCRIPTION OF THE DRAWINGS

FIG. 1 is an illustration of an exemplary implementation of a computing device that is operable to perform software execution path validation techniques.

FIG. 2 is a flow diagram depicting a procedure in an exemplary implementation in which software execution paths are validated.

FIG. 3 is another flow diagram depicting a procedure in an exemplary implementation in which symbolic simulation and path extraction are performed to validate software execution paths.

The same reference numbers are utilized in instances in the discussion to reference like structures and components.

### DETAILED DESCRIPTION

In the following discussion, exemplary devices are described which may provide and/or utilize techniques to validate software execution paths. Exemplary procedures are then described which may be employed by the exemplary devices, as well as by other devices without departing from the spirit and scope thereof.

Exemplary Devices

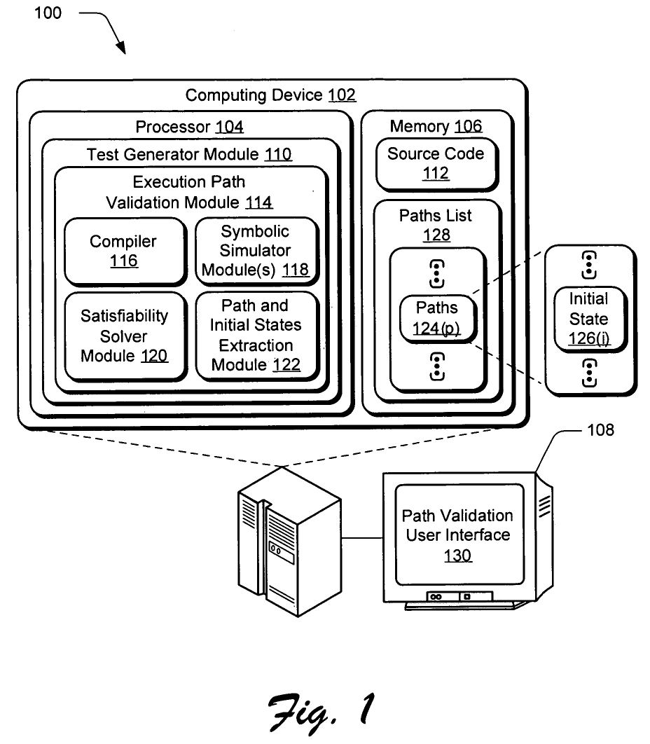

FIG. 1 illustrates an exemplary implementation 100 of a computing device 102 that is operable to employ techniques to validate software execution paths. The computing device 102 may be configured in a variety of ways, such as a traditional desktop computer (e.g., a desktop PC), a server, a notebook computer, a personal information appliance, a graphics card, and so on. Thus, the computing device 102 may be configured as a “thick” computing device having significant processing and memory resources (e.g., a server) to a “thin” computing device having relatively limited processing and/or memory resources, such as a personal information appliance. A wide variety of other configurations are also contemplated.

The computing device 102, as illustrated in FIG. 1, includes a processor 104, memory 106, and an output device, which is illustrated as a display device 108 in FIG. 1 but may assume a wide variety of other configurations, such as a network interface. The display device 108 is communicatively coupled to the processor 104 via a bus, such as a host bus of a graphics memory controller hub. The processor 104 may be configured in a variety of ways, and thus, is not limited by the materials from which it may be formed or the processing mechanisms employed therein. For example, the processor may be comprised of semiconductor(s) and/or transistors (e.g., electronic integrated circuits (ICs)), and so on. Additionally, although a single processor 104 is illustrated, the processor 104 may be representative of multiple processors that are communicatively coupled to the memory 106 through use of a bus.

The memory 106 may be representative of “main memory” of the computing device 102, persistent storage (e.g., a hard disk drive), removable computer-readable media (e.g., a digital video disc (DVD)), and other types of computer readable media. Likewise, although a single memory 106 is illustrated, the memory 106 may be representative of multiple memory devices, such as dynamic random access memory (DRAM) and a hard disk drive. A variety of other implementations are also contemplated.

The computing device 102 is illustrated as executing a test generator module 110 on the processor 104, which is also storable in memory 106. The test generator module 110 is representative of functionality to analyze source code 112 (which is illustrated as stored in memory 106) to determine whether the source code 112 will function as desired. For example, the test generator module 110, when executed, may provide inputs to the source code 108 when executed on the processor 104 and monitor a result of the execution of the source code 108. In another example, the test generator module 110, when executed, may analyze the source code 112, itself, without executing it on the processor 104, such as to analyze a structure, arrangement, variables and/or statements contained in and/or used by the source code 112.

The test generator module 110, for instance, is illustrated as including an execution path validation module 114 which is representative of functionality that is executable to automatically analyze logic behavior of software execution paths of the source code 112 for validation. To perform this validation, the execution path validation module 114 is illustrated as including a compiler 116, one or more symbolic path simulator module(s) 118 (which will be referenced in both single and plural form hereafter using a single reference number “116”), a satisfiability solver module 120 and a path and initial sates extraction module 122.

The compiler 116 is representative of functionality to produce an in-memory model of the source code 112 having a plurality of statements. For example, the model may be configured as an ordered list of labeled statements in a simple programming language (e.g., composite data-types are expanded into basic types) that has well defined formal semantics. The statements may be configured in a variety of ways, such as assignments (e.g., statements that have a functional effect on a state), conditional (i.e., branches, including indirect jumps where the target is the value of a variable computed at run-time), end of program (e.g., the source code 112 may have multiple endpoints), and so on. Thus, the statements may use simple constructs, yet are expressive enough to fully represent higher-level programs.

The symbolic simulator modules(s) 116 are representative of functionality that is executable to simulate execution paths from the in-memory module of the source code 112 generated by the compiler 116. For example, the symbolic simulator modules(s) 116, when executed, may symbolically simulate the in-memory model to compute sufficient conditions, under which, each branch in the source code 112 is to be taken.

The satisfiability solver module 120 is representative of functionality to solve conditions of the symbolic simulation generated by the symbolic path simulator module(s) 118 to eliminate “non-real” branches. The satisfiability solver module 120, for instance, may be configured as a propositional satisfiability solver (SAT) that employs an algorithmic solution to determine whether a quantified Boolean formula is satisfiable, i.e., the formula evaluates to one.

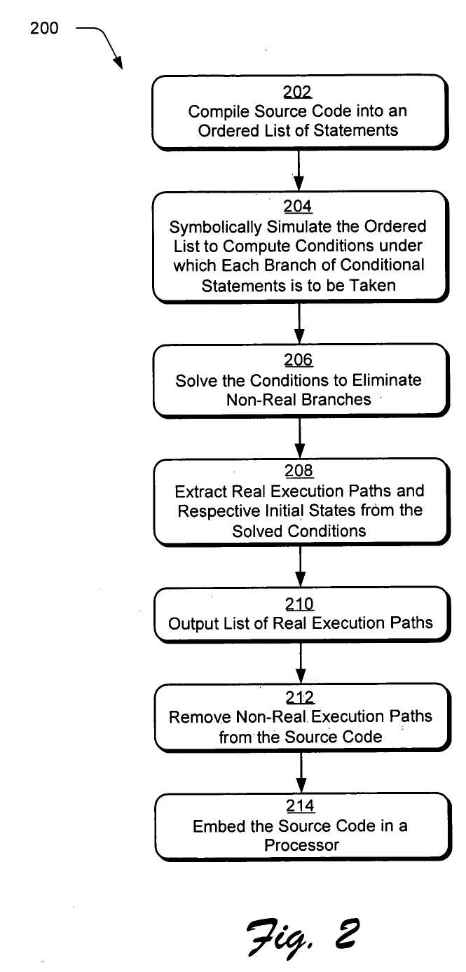

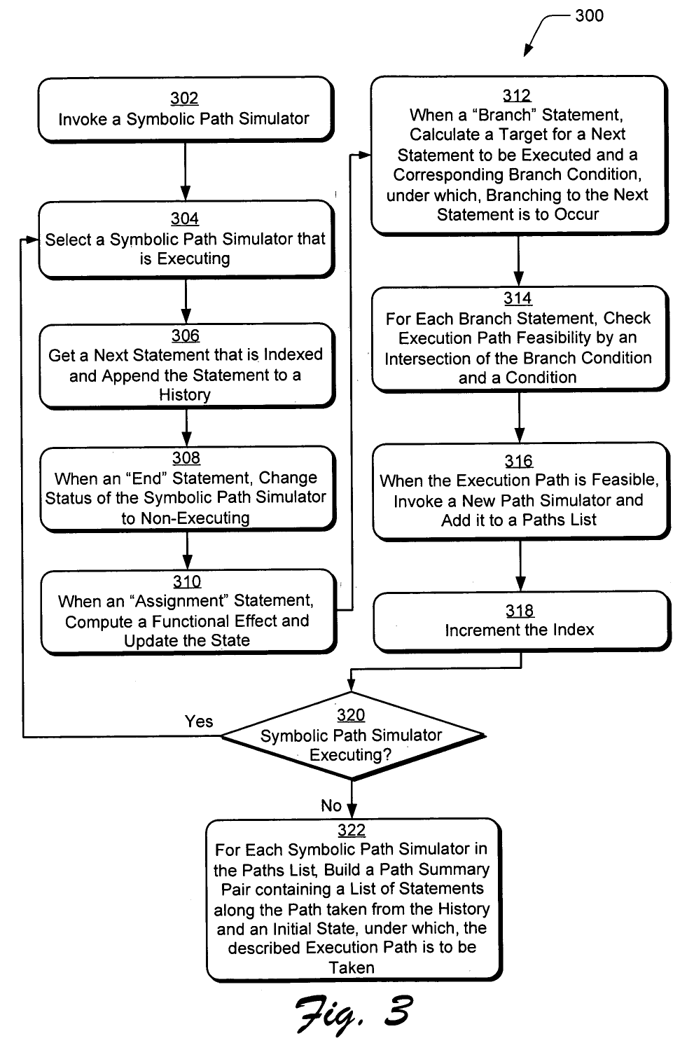

The path and initial states extraction module 122 is representative of functionality that is executable to compute real-execution paths (illustrated as “paths 124(p)” in FIG. 1, where “p” can be any integer from one to “P”). For each computed path 124(p), the path and initial states extraction module 122 is also executable to compute a set of initial states 126(i) (where “i” can be any integer from one to “I”) that, when encountered, result in execution of the respective path 124(p). The paths 124(p) and the corresponding initial states 126(i) may be stored as a paths list 128 in memory 106 and/or output via an output device, such as via a path validation user interface 130 by the display device 108. Further discussion of the execution of the test generator module 110, and in particular the compiler 116, symbolic path simulator module(s) 118, satisfiability solver module 120, and path and initial states extraction module 122 may be found in relation to FIGS. 2-3.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs such as the process 104 of FIG. 1). The program code can be stored in one or more computer readable memory devices, e.g., memory 106 of FIG. 1. The features of the techniques to provide validation techniques described below are platform-independent, meaning that the techniques may be implemented on a variety of commercial computing platforms having a variety of processors.

Exemplary Procedures

The following discussion describes software execution path validation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1.

FIG. 2 depicts a procedure 200 in an exemplary implementation in which symbolic simulation and path extraction is performed to validate software execution paths. In the following discussion, validation of microcode is described by way of example. However, it should be readily apparent that a wide variety of source code may be validated using this procedure without departing from the spirit and scope thereof.

Source code is compiled into an ordered list of statements (block 302). For example, the compiler 116 may receive source code 112 and, when executed, compile the source code 112 into a formal in-memory module. The model, for instance, may be configured as a list of conditional statement in a “simple” programming language such that composite data-types in the source code 112 are expanded into basic data-types. Further, the model may include well-defined formal semantics such that the model may be symbolically simulated.

The ordered list, for instance, may be symbolically simulated to compute conditions, under which, each branch of conditional statements included in the ordered list is to be taken (block 204). For example, the symbolic path simulator module(s) may be executed such that each execution path in the ordered list has a corresponding symbolic simulator. The corresponding symbolic simulator may also be utilized to compute the initial states as previously described, further discussion of which may be found in relation to FIG. 3.

The conditions are solved to eliminate non-real branches (block 206). The symbolically-simulated ordered list, for instance, may be analyzed by the satisfiability solver module 120 (e.g., a propositional satisfiability solver) to determine whether the branches are “real” (are quantified Boolean formulas that evaluate to one) or “non real”, e.g., that do not evaluate to one.

Real execution paths and respective initial states are then extracted from the solved conditions (block 208). The path and initial states extraction module 122, for example, when executed may form a paths list 128 that references execution paths 124(p) that are real and the corresponding initial states 126(i) as determined from solving the conditions.

The list of real execution paths is then output (block 210), which may be utilized for a variety of purposes. For example, non-real execution paths may be removed from the source code 112 such that just the real execution paths remain (block 212). The source code, having the real execution paths, may then be embedded in a processor (block 214), such as when the source code is configured as microcode. A variety of other examples are also contemplated, such as writing the source code to computer-readable media for distribution via traditional (e.g., bricks and mortar stores) and nontraditional (e.g., via the Internet) channels.

FIG. 3 depicts a procedure 300 that performs symbolic simulation and path extraction to validate software execution paths. A symbolic path simulator is invoked (block 302) starting from a symbolic initial state. The symbolic path simulator maintains a data structure throughout its execution. The data structure includes an index of statements and a list of expressions, each representing a value of variables at a current stage in the statements as a function of initial state values. The data structure also includes a condition, which is a function of the initial state values that expresses one or more conditions that are to be satisfied for the source code to reach a current location indicated by the index. Further, the data structure includes a history having a list of the statements that have been executed.

A symbolic path simulator, which is executing, is selected (block 304). A next one of the statements indexed by the index for the selected symbolic path simulator is appended to the history (block 306). When the next statement is an “end” statement, the status of the selected symbolic path simulator is changed to “non-executing” (block 308). Thus, an execution path corresponding to the symbolic path simulator is complete and another symbolic simulator may be selected, if any is executing.

When the next statement is an “assignment” statement, a functional effect of the statement is computed and the state is updated (block 310) accordingly. When the next statement is a “branch” statement, a target is calculated for a next statement to be executed and a corresponding branch condition, under which, branching to the next statement is to occur (block 312). In other words, the branch condition describes a value that, when satisfied, results in execution “down” or “along” the respective path. Further, feasibility of the execution path is checked through feasibility of the branch condition by determining an intersection of the branch condition with the condition for each branch statement (block 314), i.e., that the branch condition is included in the set of permitted conditions.

When the execution path is feasible (when the branch condition is feasible), a new symbolic path simulator is invoked and added to a paths list (block 316). Further, the new symbolic path simulator has values set equal to the index, the list, the condition and the history of the selected symbolic path simulator. In other words, the new path simulator “takes on” the already computed values of the selected path simulator such that the shared portions of the execution paths are retained. The index is then incremented (block 318).

A determination is made as to whether another symbolic path simulator is executing (decision block 320). If so (“yes” from decision block 320), the procedure 300 returns to block 304. However, when no other symbolic path simulators are executing (“no” from decision block 320), for each symbolic path simulator in the paths list a path summary pair is built containing a list of statements along the path taken from the “history” of the respective data-structure of the symbolic path simulator and an initial state, under which, the described execution path is to be taken (block 322).

Additionally, the procedure 300 may be configured to include a wide variety of optimizations. For example, a “merging” step may be used, in which, portions of paths that are shared, one with another, are reduced to a single representation that is used for both. Therefore, validation of this representation may be used for multiple execution paths-and therefore reduce repeated validation steps. A wide variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computer-implemented method comprising:
symbolically simulating an ordered list of conditional statements compiled from source code to compute conditions under which each branch of the conditional statements is to be taken; and
deriving a list of symbolically-simulated execution paths and respective initial states that, when satisfied, result in a performance of a respective said execution path.

2. A computer-implemented method as described in claim 1, wherein the source code is to be embedded in hardware.

3. A computer-implemented method as described in claim 1, further comprising verifying the derived list of execution paths by:
solving the conditions to eliminate non-real branches of the conditional statements; and
extracting real-execution paths based on the solving

4. A computer-implemented method as described in claim 3, further comprising embedding the source code in a processor after eliminating the non-real branches from the source code.

5. A computer-implemented method as described in claim 3, wherein the solving is performed by a propositional satisfiability solver.

6. A computer-implemented method as described in claim 1, further comprising verifying the derived list of execution paths by:
invoking a symbolic path simulator that maintains a data structure having:
an index of statements;
a list of expression that represents a value of variables at a current stage in the statements as a function of initial state values;
a condition which is a function of the initial state values that expresses a condition for the source code to reach a current location indicated by the index; and
a history having a list of the statements that are executed;
for each said symbolic path simulator that is executing:
selecting one of the executing symbolic path simulators;
appending a next one of the statements indexed by the index to the history;
when the next statement is a branch statement, computing each target for a subsequent statement to be executed and a corresponding branch condition under which the target is reachable and checking feasibility of the branch condition;
when the branch condition is feasible, invoking a new symbolic path simulator having values set equal to the index, the list, the condition and the history of the selected symbolic path simulator and adding the new symbolic path simulator to a paths list; and
incrementing the index; and
building, from the history, a list of statements defining the execution path and corresponding said initial states.

7. A computer-implemented method as described in claim 1, wherein:
when the next statement is an end statement, changing the at least one said symbolic path simulator to non-executing; and
when the next statement is an assignment statement, computing a functional effect of the assignment statement and updating state values accordingly.

8. A computer-implemented method as described in claim 1, wherein the symbolically simulating and the deriving are performed without using annotations received from a user.

9. A computer-implemented method as described in claim 1, wherein the symbolically simulating and the deriving are performed automatically by a computer without user intervention.

10. A computer-implemented method as described in claim 1, further comprising:
merging shared portions of a plurality of said execution paths; and
validating the shared portions, a result of which is used to validate the plurality of said execution paths.

11. One or more computer readable media comprising computer-executable instructions that, when executed, direct a computing device to verify execution paths of microcode to be embedded in a processor by:
computing conditions under which each branch of conditional statements symbolically simulated from the microcode is to be taken; and
solving the conditions to eliminate non-real branches.

12. One or more computer readable media as described in claim 11, wherein the computer-executable solve the conditions through use of a propositional satisfiability solver.

13. One or more computer readable media as described in claim 11, wherein the computer-executable instructions further direct the computing device to compile the microcode into an ordered list of statements.

14. One or more computer readable media as described in claim 13, wherein the computer-executable instructions further direct the computing device to symbolically simulate the ordered list to compute the conditions.

15. One or more computer readable media as described in claim 1, wherein the computer-executable instructions further direct the computing device to derive a list of symbolically-simulated execution paths and respective initial states that, when satisfied, result in a performance of a respective said execution path.

16. One or more computer readable media as described in claim 1, wherein the computer-executable instructions further direct the computing device to eliminate the non-real branches from the microcode.

17. One or more computer readable media as described in claim 1, wherein the verifying includes:
invoking a symbolic path simulator that maintains a data structure having:
an index of statements;
a list of expression that represents a value of variables at a current stage in the statements as a function of initial state values;
a condition which is a function of the initial state values that expresses a condition for the source code to reach a current location indicated by the index; and
a history having a list of the statements that are executed; for each said symbolic path simulator that is executing:
selecting one of the executing symbolic path simulators;
appending a next one of the statements indexed by the index to the history;
when the next statement is a branch statement, computing each target for a subsequent statement to be executed and a corresponding branch condition under which the target is reachable and checking feasibility of the branch condition;
when the branch condition is feasible, invoking a new symbolic path simulator having values set equal to the index, the list, the condition and the history of the selected symbolic path simulator and adding the new symbolic path simulator to a paths list; and
incrementing the index; and
building, from the history, a list of statements defining the execution path and corresponding said initial states.

18. One or more computer readable media as described in claim 17, wherein:
when the next statement is an end statement, changing the at least one said symbolic path simulator to non-executing; and
when the next statement is an assignment statement, computing a functional effect of the assignment statement and updating state values accordingly.

19. An apparatus comprising:
an output device;
a processor; and
memory configured to maintain one or more modules that are executable on the processor to symbolically simulate execution paths of source code, verify feasibility of the symbolically simulated execution paths, and output via the output device a list of feasible execution paths and initial conditions that, when satisfied, result in a performance of a respective said execution path.

20. An apparatus as described in claim 19, wherein the one or more modules are executable to verify the feasibility of the symbolically simulated execution paths through use of a propositional satisfiability solver.

21. An apparatus as described in claim 19, wherein the one or more modules are executable to verify by:
invoking a symbolic path simulator that maintains a data structure having:
an index of statements;
a list of expression that represents a value of variables at a current stage in the statements as a function of initial state values;
a condition which is a function of the initial state values that expresses a condition for the source code to reach a current location indicated by the index; and
a history having a list of the statements that are executed;
for each said symbolic path simulator that is executing:
selecting one of the executing symbolic path simulators;
appending a next one of the statements indexed by the index to the history;
when the next statement is a branch statement, computing each target for a subsequent statement to be executed and a corresponding branch condition under which the target is reachable and checking feasibility of the branch condition;
when the branch condition is feasible, invoking a new symbolic path simulator having values set equal to the index, the list, the condition and the history of the selected symbolic path simulator and adding the new symbolic path simulator to a paths list; and
incrementing the index; and
building, from the history, a list of statements defining the execution path and corresponding said initial states.
